(19) United States
(12) Patent Application Publication
(10) Pub. No.: US 2026/0094013 A1
(43) Pub. Date: Apr. 2, 2026

(54) Dynamic attribute split for NLP-oriented AI data analytics

(71) Applicant: Maxim Chuprunov, Schleinikon (CH)

(72) Inventor: Maxim Chuprunov, Schleinikon (CH)

(21) Appl. No.: 18/903,098

(22) Filed: Oct. 1, 2024

(51) Int. Cl. G06N 5/022; G06F 16/25

(52) U.S. Cl. CPC G06N 5/022; G06F 16/258

(57) ABSTRACT

Systems, methods, and computer algorithms disclosed herein enable dynamic adjustment of data structures in data sources used for Artificial Intelligence (AI) assisted data analytics, especially when Natural Language Processing (NLP) is used. This method includes a dynamic creation of attribute fields, definition of their names, and content based on existing datasets. Such transformation of the underlying data aims to enhance performance of NLP-based data processing by making it better match human language.

### FIELD OF THE INVENTION

The present invention generally relates to data analytics with the help of AI technology, and more particularly to systems, methods and computer algorithms applied to the data in data sources in order to adjust it in a special way referred to as “dynamic attribute split”, improving the performance of such data analytics.

### BACKGROUND

AI technology is increasingly being used to provide additional insights into specific sets of data. Such data analytics usually involve humans providing requests in a natural language (NL) format and seeking actionable insights from data stored in business, healthcare, social networks, and other applications.

While types of AI-assisted data processing can vary, current technology often deploys generative AI leveraging advanced language models due to the need to process human input in natural language (NL) format. Natural Language (NL) to SQL processing is one of the most frequently used scenarios. All types of AI-assisted data analytics share common metrics such as execution accuracy and precision, among others, which are crucial for delivering correct results.

Usual approaches in NLP-oriented AI models leverage traditional principles adopted for online analytical data processing, but encounter challenges in delivering correct results when tasked with analyzing complex datasets. Especially when human requests and data sources contain many complex attributes, the generation of prompts, queries and other relevant technical steps of Al-aided data analytics can fail in providing correct results.

There are several ways to improve performance of AI-aided data analytics in NLP-oriented AI models. From the perspective of re-usability of improvement measures and efforts, those ways can be grouped in 2 categories: 1st, ways specific to the underlying data and to the setup (e.g., model training, reinforcement learning from human feedback, adding use case-specific glossaries, synonym tables, etc.) or 2nd, use-case independent and more universal ways, which can be typically applied in the areas of data quality in preprocessing.

Given the foregoing, what is needed are systems, methods, and computer program products that help maximize the performance of NLP-based AI data analytics in a universally reusable way.

### SUMMARY

This summary is provided to introduce the main concepts behind the present invention. These concepts are further described below in the Detailed Description. This summary is not intended to identify key features or essential features of the claimed subject matter, nor is this summary intended as an aid in determining the scope of the claimed subject matter.

The present invention meets the above-identified needs by providing systems, methods and computer program products allowing to improve performance of AI-aided data analytics by structuring the data source in a special way. AI language models are primarily trained on human-generated text data, and the dynamic attribute split helps to pre-process data, making it better match human language.

In an embodiment, this better match to human language is achieved by eliminating the differentiation of meaning between column name and column value, and combining them both into one new column name, thus establishing more comprehensive column names in general. Furthermore, only generalized column values like “yes”or “no” are established within transformed data.

In an embodiment, the invention helps to keep the transformed data up-to-date while the underlying data is changing. As new data is added or existing data is modified in the data source, the dynamic attribute splitting process is repeated ongoingly, or matching the frequency of the underlying data change. Hence, the structure of the optimized data exposed to the AI-aided analytics can be constantly changing. This ongoing (or: dynamic) adjustment ensures that the AI-aided data analytics always work with the data structured in accordance with the dynamic attribute split method.

In an embodiment, pre-processing of the data in accordance with the dynamic attribute split method can be universally applied in an automated way for all AI data analytics use cases and types of data.

Based on the core features mentioned above, the present invention provides systems, methods, and computer programs that help to augment AI models' data analysis capabilities, with a particular focus on NLP scenarios. By transforming attribute data within datasets, the invention facilitates a better understanding and processing of the data, leading to improved performance of AI models.

### BRIEF DESCRIPTION OF THE DRAWINGS

The features and advantages of the present invention will become more apparent from the detailed description below, when considering the drawings and individual elements within it.

FIG. 1 is a block diagram describing a general structure of an AI-assisted data analytics and how attribute split is situated within it.

FIG. 2 describes the notion of the attribute split, based on one exemplary attribute column.

FIG. 3 provides another attribute split example, referring to multi-value attribute columns.

FIG. 4 is a flow chart diagram illustrating the attribute split algorithm, applied to a set of data within a data source.

### DETAILED DESCRIPTION

The present invention is directed to systems, methods and computer program products that provide a framework for the automated dynamic attribute split in data sources used for NLP-oriented AI data analytics.

In an embodiment, the present invention provides systems, methods and computer program products that improve performance metrics of NLP-oriented AI data analytics by pre-processing the data in the data source, making this data better match human language.

Some embodiments of this disclosure, illustrating all its features, will now be discussed in detail. The words “comprising,” “having,” “containing,” and “including,” and other forms thereof, are intended to be equivalent in meaning and be open-ended in that an item or items following any one of these words is not meant to be an exhaustive listing of such item or items, or meant to be limited to only the listed item or items.

It must also be noted that, as used herein and in the appended claims, the singular forms “a,” “an,” and “the” include plural references unless the context dictates otherwise. Although any systems and methods similar or equivalent to those described herein can be used in the practice or testing of embodiments of the present disclosure, the preferred systems and methods are now described.

Embodiments of the present disclosure will be described more fully hereinafter with reference to the accompanying drawings, in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

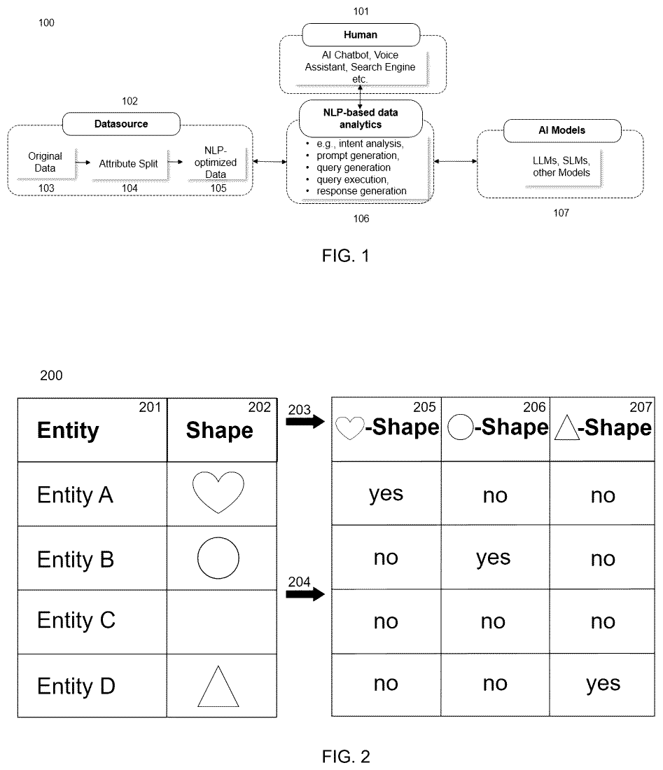

### FIG. 1 Example of a General System for Dynamic Attribute Splitting in NLP-based AI Data Processing.

FIG. 1 illustrates the topology of the NLP-based AI data processing system used as an example (100). In such a system, a request is submitted by a human (101) in a natural language through a chatbot, voice assistants, search engines and other interfaces. The same interface is used later to receive responses generated by AI models, as described below, containing data analytics results.

Requests submitted by humans in natural language are then processed as a part of NLP-based data analytics (106), which can include various steps such as intent analysis, prompt generation, query generation, query execution, and response generation. Various AI Models (107), e.g. Large Language Models (LLMs), Small Language Models (SLMs), and other AI models, assist in performing those tasks within the NLP-based data analytics.

In general, dynamic attribute splitting disclosed in this invention preprocesses data in the Data Source (102) before exposing it to AI models and logic. The NLP-based AI data processing uses the NLP-optimized data (105), which is derived from Original Data (103) with the means of the Attribute Split (104) disclosed in this invention. This Attribute Split (104) is repeated depending on the changes in the underlying data, thus being of dynamic nature, and ensuring that the NLP-optimized data is up-to-date at any point of time Data (103).

The pre-processing disclosed helps Data to better match the Natural Language, thereby improving the performance of NLP-based AI models. This improved performance can be relevant for several steps within NLP-based data analytics (106), such as intent analysis, prompt generation, query generation and execution, and response generation.

### FIG. 2 Detailed Description Example of Dynamic Attribute Splitting for Entity Shapes

FIG. 2 illustrates an example of the dynamic attribute split process applied to a data source, which contains entities and their associated shapes (200). The original data source on the left side includes two columns: the key column “Entity” (201) and the attribute column “Shape” (202). One single attribute column contains therefore respective attribute values for all Entities, e.g. heart shape for the entity “Entity A”, the circle shape for the “Entity B”, no shape for the “Entity C”, and the triangle shape for the “Entity D”.

The dynamic attribute splitting applied to the original data source comprises two main steps: first, changes to the fields structure (203), including removal of the original and inclusion of new attribute columns. Second, population of those new fields with new Natural Language-oriented values (204), indicating applicability of the adjusted attribute values to each respective entity. Both steps are part of the overall dynamic attribute split process and are repeated continuously in order to reflect changes of data.

In more detail, the dynamic attribute split process begins by identifying attribute values (unique shape categories in our case) mentioned in the “Shape” column (202) of the original table. In our example (200), the attribute values identified are heart, circle, and triangle. Based on these attribute values, names for new columns are defined, and columns are created in the transformed data source to represent each attribute value independently as a part of the first step (203). As a result, new attribute columns are created instead of the original column “Shape” (202). Those new attribute columns combine the original attribute column name (“Shape”) and the actual attribute value in their names, resulting in the following three new columns (or: metadata): “Heart-Shape” (205), “Circle-Shape” (206), and “Triangle-Shape” (207). For NLP-aided AI analytics purposes, the resulting metadata in the data source exposed to AI logic can combine graphical and textual information.

Next to the definition of new columns, their content is being updated with the new value. Those new values set describing the applicability of Attributes for each Entity in a Natural Language format. In our example (200), the resulting values in the new columns (205, 206 and 207) are “Yes” and “No”. In general, depending on the attributes and their context, any other applicability-related characteristics in Natural Language can be used (e.g., “partly”, “fully”etc.).

The final Data Source contains transformed (or: split, pre-processed) attribute columns (205, 206 and 207) as shown on the right side of FIG. 2, with applicability-related values for each “Entity” (201). As compared to the original attribute column “Shape” (202), those new columns cumulatively contain the same information, but less fragmented from a semantic perspective and presented in the closer to the Natural Language format. Overall, this approach improves the ability of the Artificial Intelligence to understand, interpret, and respond to human input.

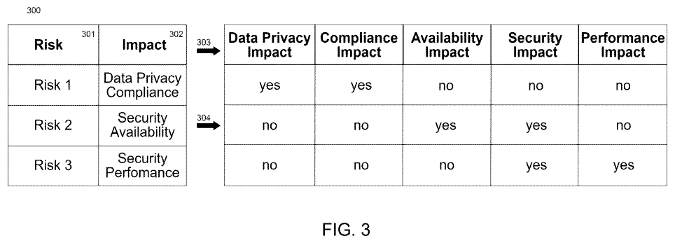

### FIG. 3: Dynamic Attribute Splitting for Multi-Value Risk Impact Analysis

FIG. 3 provides another example of the dynamic attribute split process applied to a dataset containing risk impact information. The original data source structure (300) on the left side includes two columns: the key column “Risk” (301) and the attribute column “Impact”(302), which can contain multiple values.

Initially, the table includes entries such as “Risk 1” with several impact values “Data Privacy” and “Compliance”, “Risk 2” with values “Security” and “Availability,” and “Risk 3” with values “Security” and “Performance.”

In the same way as described in the previous figure FIG. 2, the splitting process begins by transforming the attribute column (302) into several new attribute column (303), which combine both the attribute column Name and all available attribute values in each column separately. Following this approach, the resulting data structure has less fragmentation from a semantic point of view, which is relevant for the NLP-based processing.

Values for the newly created (or: split, transformed) fields (303) are updated in the next step, reflecting the applicability of each attribute for each entry in Natural Language format.

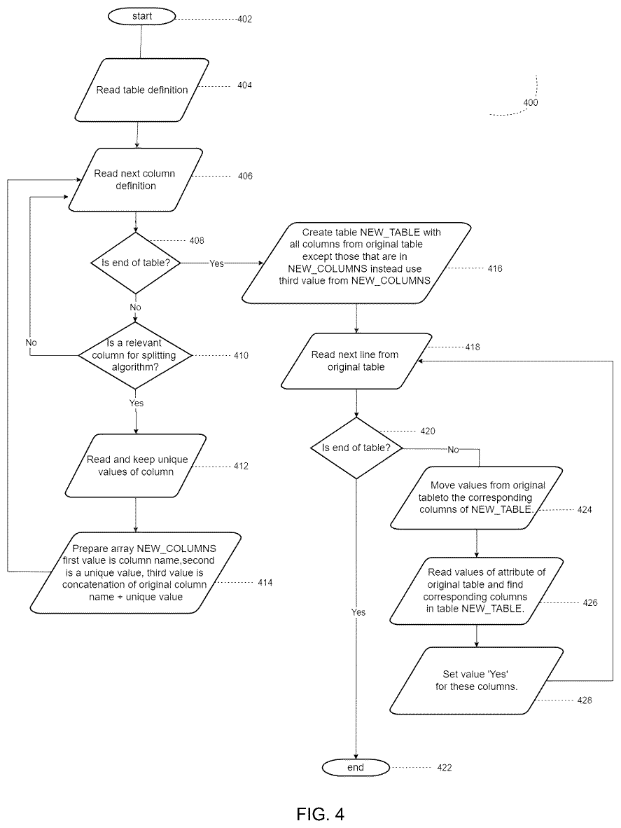

### FIG. 4: Flowchart of the Dynamic Attribute Splitting Algorithm

FIG. 4 (400) depicts the sequence of steps used to dynamically split attributes in a database table, which serves as a data source for NLP-based data analytics. The data transformation, as described in the previous examples (FIG. 2 and FIG. 3), can be accomplished following this universal algorithm, which can be applied to any other structured data.

The process starts (402), with reading the table definition (404), which means understanding the structure of the original data, including column names and data types. The algorithm then reads each column definition one by one (406) and checks if it has reached the end of the table (408). If not, it checks if the current column is relevant for the attribute splitting process (410).

If the column is relevant, the algorithm finds and stores unique values within that column (412). These unique values will be used to create new columns. An array called NEW_COLUMNS is prepared (414), which includes the original column name, the unique values, and a new name for each unique value.

As soon as the end of the table is reached, a new table (NEW_TABLE) (416) is being created. This new table includes all columns from the original table except those that are being split. Instead, it uses the new names from the NEW_COLUMNS array. The algorithm reads each row from the original table (418) and moves the values to the appropriate columns in the new table.

For each row, the algorithm checks again if it has reached the end of the table (420). If not, it reads the attribute values and finds the matching columns in the new table (426). The values from the original table are moved to the new columns (424), and a “Yes” or “No” value is set to indicate the presence of each value (428).

As soon as the end of the table is reached (420), the attribute split is complete (422). The algorithm is repeated continuously or based on the frequency of changes in the updated data in the table. This described process transforms the data into a better format for NLP tasks, allowing AI models to perform more accurately and efficiently.

1. A method for attribute splitting to enhance the data analysis capabilities of AI models, comprising techniques for identifying and transforming distinct attribute data within datasets.

2. A system for attribute splitting integrated with AI models that facilitates improved efficiency and accuracy in data analysis tasks, particularly in applications involving Natural Language Processing (NLP).

3. A novel algorithm for increasing the success rate of deriving correct SQL logic from natural language input, utilizing an attribute splitting technique in AI models.
